(19) United States
(12) Patent Application Publication
(10) Pub. No.: US 2007/0222309 A1
(43) Pub. Date: Sep. 27, 2007

(54) High efficiency magnet motor

(76) Inventor: Gary A. Minker, Lake Worth, FL (US)

Correspondence Address: DAVIS CHIN, 10281 WEST LINCOLN HIGHWAY, FRANKFORT, IL, 60423, US

(21) Appl. No.: 11/389,329

(22) Filed: Mar. 27, 2006

(51) Int. Cl. H02K 37/00; H02K 49/00; H02K 21/00; H02K 53/00

(52) U.S. Cl. 310/46; 310/103; 310/152

(57) ABSTRACT

A high efficiency non-electrically induced magnet motor includes a stator assembly and a rotor assembly having a rotor shaft extending therethrough at its center and disposed operatively for relative rotation respect to the stator assembly about the rotor shaft between a counter-clockwise direction and a clockwise direction. First and second groups of magnets are affixed to respective top and lower surfaces of an outer field magnet holder plate of the stator assembly. A third group of magnets is affixed to a top surface of an inner core magnet holder plate of the stator assembly. Fourth and fifth groups of magnets are affixed to respective top and lower surfaces of a rotor plate of the rotor assembly. First and second flux gate window control devices are provided for selectively allowing repulsive flux from the first through third groups of stator magnets to be coupled to the fourth and fifth groups of rotor magnets for causing rotation of rotor assembly between the counter-clockwise and clockwise directions.

### BACKGROUND OF THE INVENTION

1. Field of the Invention

This invention relates generally to magnetically operated motors and more particularly, the present invention relates to an improved high efficiency non-electrically induced magnetic motor, utilizing the effects of stored energy within first through fifth groups of permanent magnets, which is operable independent of gasoline fuel and other similar energy sources so as to avoid contamination of the environment.

2. Description of the Prior Art

As is generally well-known, there have been produced over the past many years a vast quantity of automotive vehicles, trucks, boats, airplanes and other like machinery which rely heavily upon the use of petroleum fuel such as gasoline for its operation. The consumption of the gasoline required to operate internal combustion engines in these various automotive vehicles and/or machinery causes pollution to the environment. Further, in recent times the cost of gasoline has been increasingly higher and higher each year due the reduced amount that is being produced.

Accordingly, it would be desirable to provide an improved high efficiency non-electrically induced magnetic motor which utilizes the effects of stored energy within different groups of permanent magnets and which is relatively simple and inexpensive in design, construction, and operation. It would also be expedient that the high efficiency magnet motor be operable independent of gasoline fuel and other similar energy sources so as to avoid contamination of the environment.

A prior art search directed to the subject matter of this application in the U.S. Patent and Trademark Office revealed the following Letters Patent and application:

3,895,245
4,305,024
4,314,169
4,357,557
4,864,199
5,258,677

In U.S. Pat. No. 3,895,245 to Bode issued on Jul. 15, 1975, there is disclosed an electric motor which includes two counter-rotating rotors that are intermeshed by gears and each carrying a plurality of permanent magnets radially arranged with the same poles at its periphery thereof. A shield of magnetic material is disposed at one side extending partly around the periphery of each rotor and into the substantially the bite of the rotors. An electromagnet is arranged with its one pole adjacent the bite of the rotors. When the rotors reach the bite thereof, the electromagnet is energized so as to create a pole of opposite polarity to the outer poles of the rotors, thereby pulling the permanent magnets around in the direction of rotation. After passing the dead-center point, the repelling force will cause the turning of the rotors to continue. The other magnets approaching the shield are attracted to each other so as to cause continuous rotation of the rotors.

In U.S. Pat. No. 4,314,169 to Rusu issued on Feb. 2, 1982, there is taught an electromagnetic motor which includes a plurality of electromagnetic coils positioned adjacent to a shaft and a plurality of pairs of permanent magnets mounted the shaft. As each pair of permanent magnet pass successively past a coil with a pole of each permanent magnet adjacent to pole of the same polarity of the coil, d.c. electric energy is momentarily supplied to the coil for producing mutually repulsive forces for causing the shaft to rotate.

In U.S. Pat. No. 4,305,024 to Kuroki issued on Dec. 8, 1981, there is taught a magnet motor which includes a plurality of electromagnets mounted around the circumference of a housing and connected to an excitation circuit. A rotor assembly includes a plurality of permanent magnets disposed around its periphery and are arranged for angular movement. The permanent magnets are movable between the respective electromagnets. The electromagnets are selectively excited through the excitation circuit for being magnetized to have the same pole as the pole of a respective one of the permanent magnets disposed closely adjacent them. As a result, the rotor assembly is caused to angularly move under the influence of magnetic repulsive forces exerted by the respective closely adjacent electromagnets and permanent magnets.

U.S. Pat. No. 4,864,199 issued on Sep. 5, 1989 to Dixon discloses an electronically controlled electric motor which includes a rotor having a plurality of permanent magnets seated in recesses spaced equiangularly and circumferentially symmetric around its periphery and a stator having a plurality of electromagnets spaced equiangularly and circumferentially symmetric around its periphery. Each of the electromagnets consists of a winding formed on a core. The windings of the electromagnets are energized so that they will cooperate with the permanent magnets of the rotor for causing its rotation.

The remaining patents, listed above but not specifically discussed, are deemed to be only of general interest and show the state of the art in motors of the type which utilizes a combination of electromagnets and permanent magnets for effecting rotation of the motor components.

None of the prior art discussed above discloses a high efficiency non-electrically induced magnet motor like that of the present invention which includes first through third groups of magnets affixed to a stator assembly and fourth and fifth groups of magnets affixed to a rotor assembly for producing mutually repulsive forces to cause rotation of the rotor assembly between counter-clockwise and clockwise directions.

### SUMMARY OF THE INVENTION

Accordingly, it is a general object of the present invention to provide an improved high efficiency non-electrically induced magnet motor which is relatively simple and inexpensive in design, construction and operation.

It is an object of the present invention to provide a high efficiency magnet non-electrically induced motor which is operable independent of gasoline fuel and other similar energy sources so as to avoid contamination of the environment.

It is another object of the present invention to provide a high efficiency non-electrically induced motor which includes first through third groups of magnets affixed to a stator assembly and fourth and fifth groups of magnets affixed to a rotor assembly for producing mutually repulsive forces to cause rotation of the rotor assembly between counter-clockwise and clockwise directions.

It is still another object of the present invention to provide a high efficiency non-electrically induced magnet motor which includes flux gate window control devices to selectively allow repulsive forces from first through third groups of stator magnets to be coupled to fourth and fifth groups of rotor magnets for causing rotation of a rotor assembly between counter-clockwise and clockwise directions.

In a preferred embodiment of the present invention, there is provided a high efficiency magnet motor formed of a stator assembly and a rotor assembly. The stator assembly includes an outer field magnet holder plate, an inner core magnet holder plate, an upper yoke bracket, and a lower yoke bracket. The rotor assembly has a rotor shaft extending therethrough at its center and is disposed operatively for relative rotation respect to the stator assembly about the rotor shaft between a counter-clockwise direction and a clockwise direction. The outer field magnet holder plate has a circular cut-out section in its central portion for receiving therein the inner core magnet holder plate and the rotor assembly.

A first group of magnets is affixed to a top surface of the outer field magnet holder plate. The first group of magnets consists of a first plurality of counter-clockwise field permanent magnets spaced apart equiangularly and circumferentially symmetric around an inner peripheral edge. A second group of magnets is affixed to a lower surface of the outer field magnet holder plate. The second group of magnets consists of a second plurality of clockwise field permanent magnets spaced apart equiangularly and circumferentially symmetric around the inner peripheral edge. The inner core magnet holder plate being formed of a circularly-shaped disc having a top surface and a bottom surface.

A third group of magnets is affixed to the top surface of the inner core magnet holder plate. The third group of magnets consists of a third plurality of counter-clockwise inner core permanent magnets spaced apart equiangularly and circumferentially symmetric around an outer peripheral edge. The rotor assembly includes a circularly-shaped rotor plate having a top surface and a bottom surface.

A fourth group of magnets is affixed to the top surface of the rotor plate. The fourth group of magnets consists of a fourth plurality of counter-clockwise direction induced rotor plate mounted permanent magnets spaced apart equiangularly and circumferentially symmetric around an outer peripheral edge of the rotor plate. A fifth group of magnets is affixed to the lower surface of the rotor plate. The fifth group of magnets consists of a fifth plurality of clockwise direction induced rotor plated mounted permanent magnets spaced apart equiangularly and circumferentially symmetric around the outer peripheral edge of the rotor plate.

A first flux gate window control device is provided for selectively allowing repulsive flux from the counter-clockwise inner core permanent magnets to be coupled to the counter-clockwise direction induced rotor plated mounted permanent magnets for causing rotation of rotor assembly in the counter-clockwise direction. A second flux gate window control device is provided for selectively allowing repulsive flux from one of the counter-clockwise and clockwise field permanent magnets to be coupled to a corresponding one of the counter-clockwise and clockwise direction induced rotor plate mounted permanent magnets for causing rotation of rotor assembly between the counter-clockwise and clockwise directions.

These first and second flux gate window control devices may be operated as to engage either flux gap between either grouping of magnets independently as to promote rotation in either direction or to promote a braking action to be caused by operating the magnet flux gaps simultaneously.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is a perspective view of a high efficiency magnet motor in its fully assembled condition, constructed in accordance with the principles of the present invention;

FIG. 2 is a perspective view of the stator assembly of the magnet motor of FIG. 1;

FIG. 3 is a perspective of the outer field and inner core holder plates of FIG. 2 with magnets mounted;

FIG. 4 is a perspective of the rotor assembly of the magnet motor of FIG. 1;

FIG. 5 is a perspective view of the flux gate control devices of the magnet motor of FIG. 1;

FIG. 6 is a top plan view of the inner core magnets, rotor magnets, and outer field magnets for counter-clockwise rotation of the magnet motor of FIG. 1; and

FIG. 7 is a top plan view of the rotor magnets and outer field magnets for clockwise rotation of the magnet motor of FIG. 1.

### DESCRIPTION OF THE PREFERRED EMBODIMENTS

It is to be distinctly understood at the outset that the present invention shown in the drawings and described in detail in conjunction with the preferred embodiments is not intended to serve as a limitation upon the scope or teachings thereof, but is to be considered merely as an exemplification of the principles of the present invention.

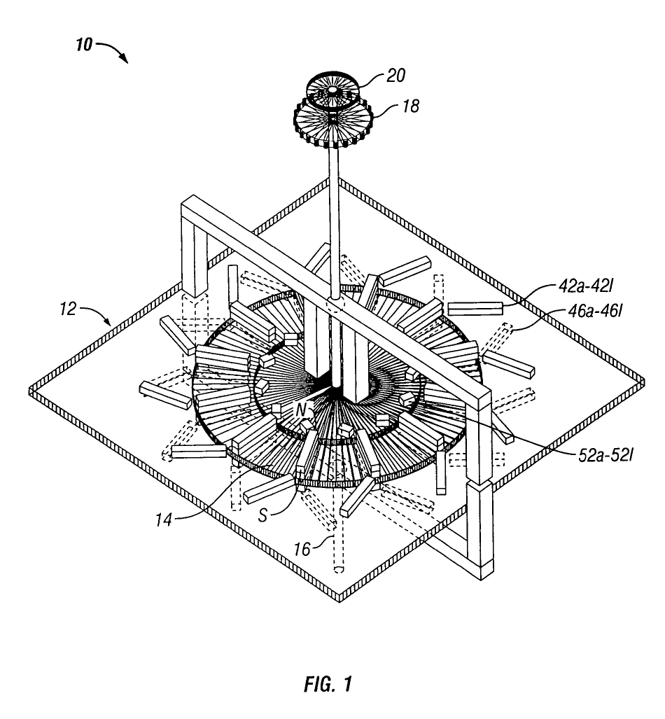

Referring now in detail to the various views of the drawings, there is illustrated in FIG. 1 a perspective view of a high efficiency magnetic motor 10 in its fully assembled condition, constructed in accordance with the principles of the present invention. The magnetic motor 10 is comprised of a stationary or stator assembly 12 and a relatively rotatable assembly 14 which is also referred to as a rotor or armature assembly. The stator assembly may be formed of any appropriated shape to be operatively supported within a housing or casing (not shown).

The rotor assembly 14 is mounted rotatably on a rotor shaft 16. A power take-off gear 18 is also mounted rotatably on the rotor shaft 16 from which power, work or force from the rotating rotor assembly 14 can be removed or extracted. A brake assembly includes a brake 20 which is meshed with the gear 18 so to cause slowing, stopping and/or station keeping of the rotation of the rotor assembly 14.

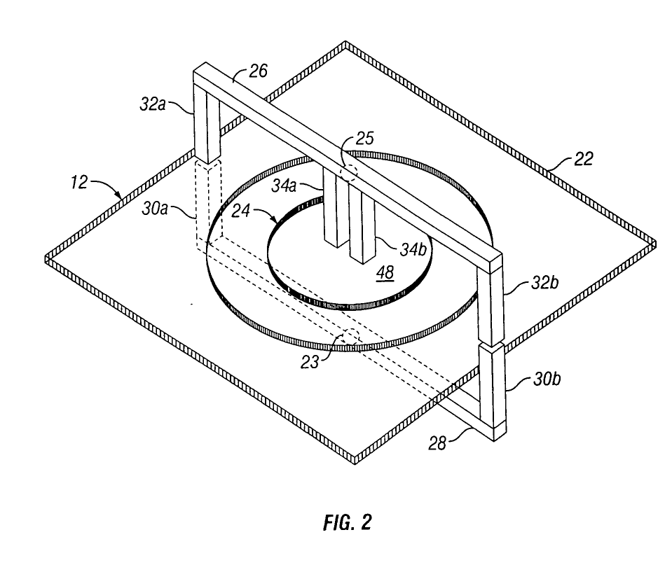

As can be seen from FIG. 2, the stator assembly 12 includes an outer field or stator magnet plate holder 22, an inner core or stator magnet plate holder 24, an upper yoke bracket 26, and a lower yoke bracket 28. The lower yoke bracket 28 is formed of a generally U-shaped construction and has a pair of arms 30a and 30b attached to the lower surface of the outer field magnet holder plate 22 so as to provide rotational stability for bearing 23 which holds the rotor assembly 14. The upper yoke bracket 26 is also formed of a generally U-shaped construction and has a pair of outer arms 32a and 32b and a pair of inner arms 34a and 34b. The outer arms 32a and 32b are attached to the upper surface of the outer field magnet holder plate 22, and the inner arms 34a and 34b are attached to the upper surface of the inner core magnet holder plate 24 so as to provide a similar rotational stability for bearing 25 which holds the rotor assembly 14. The rotor shaft 16 supports the rotor assembly 14 and interfaces with the upper and lower yoke brackets 26, 28, as shown in FIG. 2.

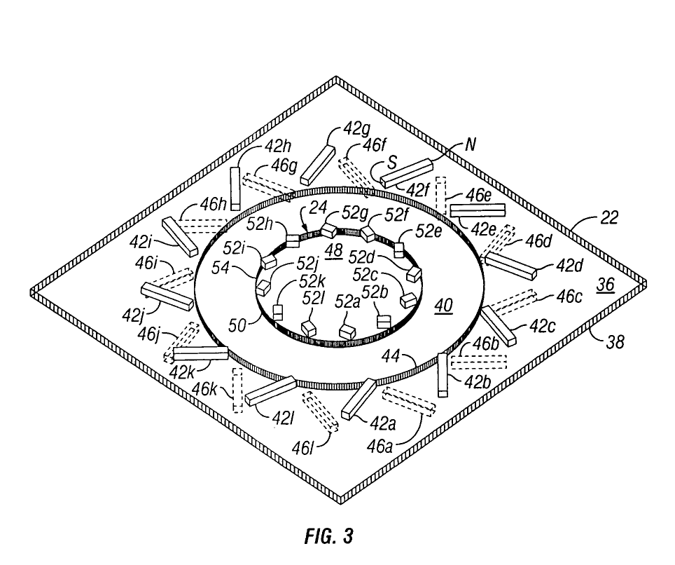

In FIG. 3, the outer field magnet holder plate 22 is formed of substantially square shape having a top surface 36 and a lower surface 38. In the central portion of the holder plate 22, there is provided a circular cut-out section 40 which receives the rotor assembly (not shown) and the inner core magnet holder plate 24. The top surface 36 of the outer field magnet holder plate 22 includes a first group of magnets consisting of a plurality (twelve as shown in the exemplary motor) of counter-clockwise field permanent magnets 42a-42l which are flush-mounted thereon in a plane above top surface. These permanent magnets 42a-42l are spaced apart equiangularly and circumferentially symmetric around the inner peripheral edge 44. Further, the permanent magnets 42a-42l are oriented so that the same pole of each magnet (south in the exemplary motor) is adjacent to the inner peripheral edge 44.

Similarly, the lower surface 38 of the holder plate 22 includes a second group of magnets consisting of a plurality (twelve as shown in the exemplary motor) of clockwise field permanent magnets 46a-46l which are flush-mounted thereon in a plane below the lower surface. These permanent magnets 46a-46l are also spaced apart equiangularly and circumferentially symmetric around the inner peripheral edge 44. Further, the permanent magnets 46a-46l are oriented so that the same pole of each magnet (south in the exemplary motor) is adjacent to the inner peripheral edge 44.

The inner core magnet holder plate 24 is formed of a circular shape having a top surface 48 and a lower surface 50. The top surface 48 of the holder plate 24 includes a third group of magnets consisting of a plurality of counter-clockwise inner core permanent magnets 52a-52l which are flush-mounted thereon in a plane above the top surface 48. These permanent magnets 52a-52l are spaced apart equiangularly and circumferentially symmetric around the outer peripheral edge 54 of the holder plate. Further, the permanent magnets 52a-52l are oriented so that the same pole of each magnet (north in the exemplary motor) is adjacent to the outer peripheral edge 54. It will noted that the major axes of the counter-clockwise field permanent magnets 42a-42l are lying perpendicularly or 90 degrees to the major axes of the corresponding clockwise field permanent magnets 46a-46l.

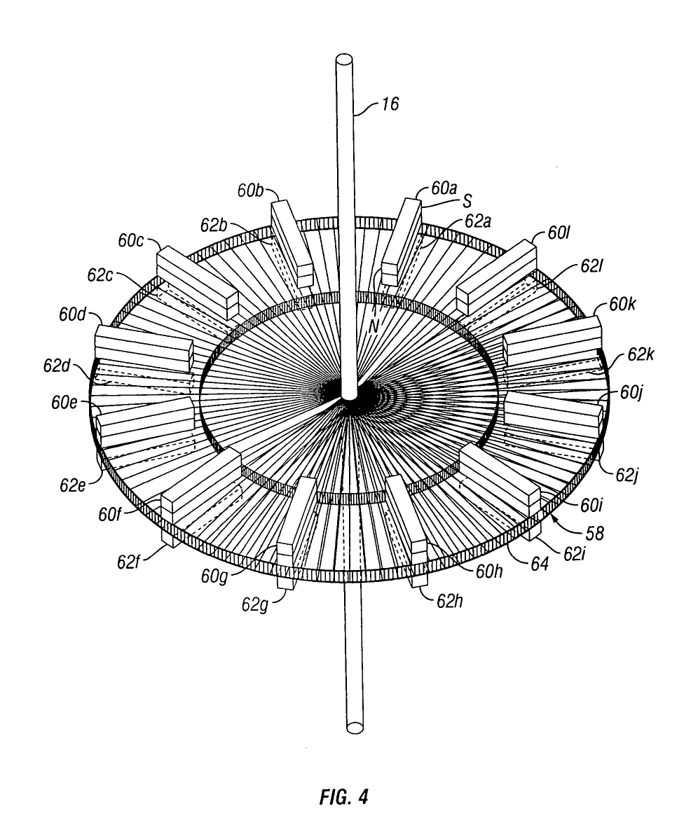

In FIG. 4, there is illustrated the details of the rotor assembly 14 which consists of a circularly-shaped rotor plate 58, a fourth group of magnets formed of a plurality (twelve as shown in the exemplary motor) of counter-clockwise direction induced rotor plate mounted permanent magnets 60a-60l, and a fifth group of magnets formed of a plurality of clockwise direction induced rotor plate mounted permanent magnets 62a-62l. It will be noted that the rotor shaft 16 extends through the center of the rotor plate 58 for supporting the rotor assembly 14. The plurality of counter-clockwise direction induced rotor plate mounted permanent magnets 60a-60l are flush-mounted on the top surface of the rotor plate.

These magnets 60a-60l are spaced apart equiangularly and circumferentially symmetric around the outer peripheral edge 64 of the rotor plate. In addition, the magnets are oriented with their major axes lying along the radii of the rotor plate where each magnet has the same pole (north) facing the outer surface (north) of a corresponding one of the counter-clockwise inner core permanent magnets 52a-52l and has the same pole (south) facing the inner surface (south) of a corresponding one of the counter-clockwise outer field permanent magnets 42a-42l.

Similarly, the plurality of clockwise direction induced rotor plated mounted permanent magnets 62a-62l are flush-mounted on the lower surface of the rotor plate. These magnets 62a-62l are also spaced apart equiangularly and circumferentially symmetric around the peripheral edge 64 of the rotor plate. In addition, the magnets are oriented with their major axes lying along the radii of the rotor plate where each magnet has the same pole (south) facing the inner surface (south) of a corresponding one of the clockwise outer field permanent magnets 46a-46l.

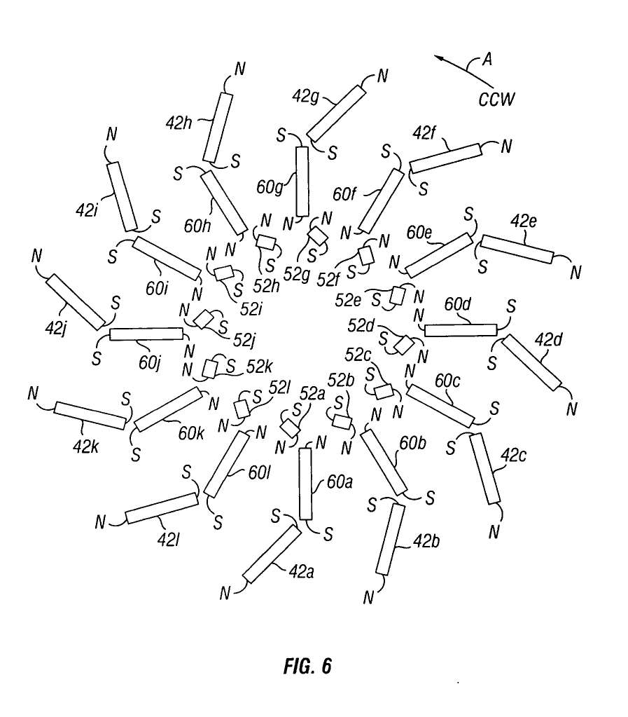

The counter-clockwise rotational operation of the magnet motor 10 will now be described with reference to FIG. 6 which, for the sake of clarity, illustrates only the counter-clockwise outer field magnets 42a-42l, the counter-clockwise direction induced rotor plate mounted magnets 60a-60l, and the counter-clockwise inner core magnets 52a-52l all positioned in a level and common plane so as to allow the counter-clockwise rotation of the rotor plate 58 to develop. Initially, it should be clearly understood that the rotor assembly 14 must be disposed into the circular cut-out section 40 between the inner stator plate 24 and the outer stator plate 22 so as to realize the orientation of the permanent magnets as illustrated in FIG. 6.

In this fashion, it can be seen that each adjacent pole pair of the fields of the counter-clockwise field magnets 42a-42l and the counter-clockwise rotor plate magnets 60a-60l are of the same polarity (south) and that each adjacent pole pair of the fields of the counter-clockwise inner core magnets 52a-52l and the counter-clockwise rotor plate magnets 60a-60l are of the same polarity (north). In other words, the counter-clockwise rotor magnets 60a-60l are oriented so as to present a negative face (south) to the inner surface (south) of the outer stator magnets 42a-42l while the positive face (north) is presented to the outer surface (north) of the inner core magnets 52a-52l.

As a result, there will be produced mutually repulsive forces at a multiplicity of locations simultaneously so as to magnify the forces exerted on the rotor plate which, in turn, causes the rotor shaft connected thereto to rotate. This positionally pulsed repulsion of forces will generate continuously a fly-wheel action of the rotor plate for effecting counter-clockwise rotation in the direction of the arrow A.

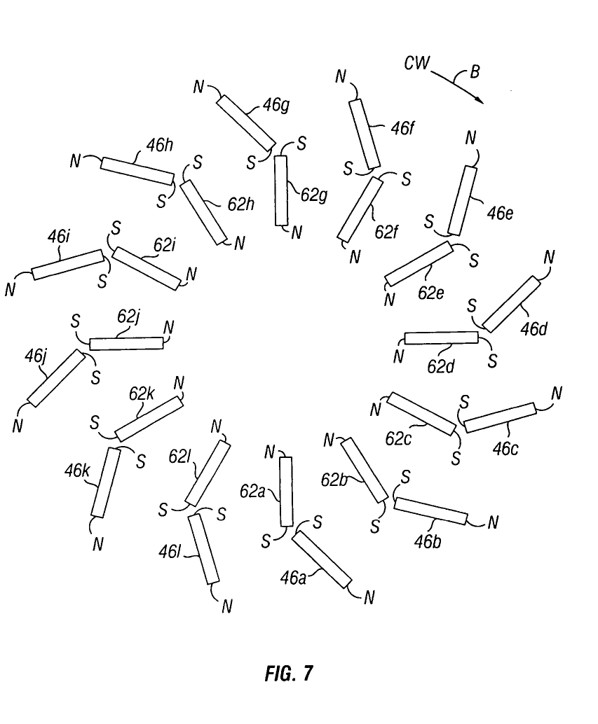

Likewise, for clockwise rotational operation, as shown in FIG. 7, each adjacent pole pair of the fields of the clockwise field magnets 46a-46l and the clockwise rotor plate magnets 62a-62l are of the same polarity (south). In other words, the clockwise rotor magnets 62a-62l are oriented so as to present a negative face (south) to the inner surface (south) of the outer stator magnets 46a-46l.

As a result, there will be produced again mutually repulsive forces at a multiplicity of locations simultaneously so as to magnify the forces exerted on the rotor plate which, in turn, causes the rotor shaft connected thereto to rotate. This positionally pulsed repulsion of forces will generate continuously a fly-wheel action of the rotor plate for effecting clockwise rotation in the direction of the arrow B.

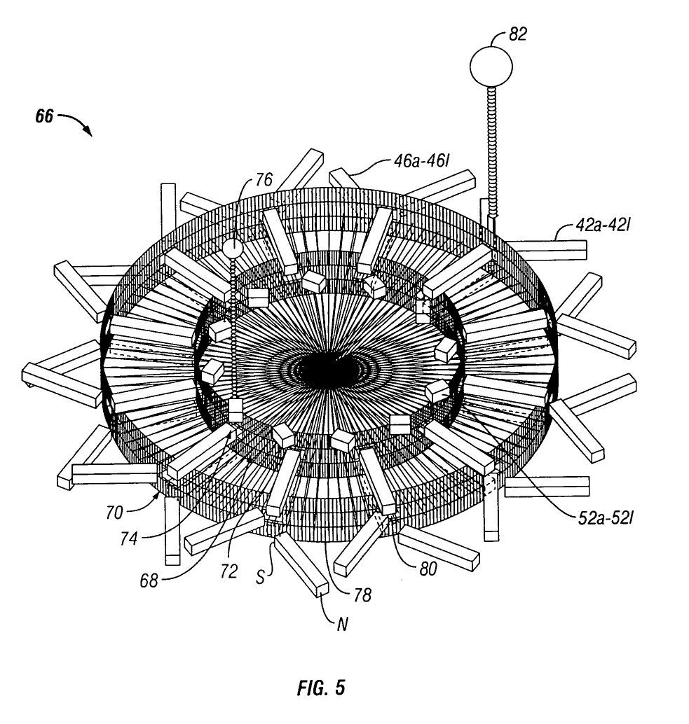

One exemplary system for controlling the counter-clockwise and clockwise operation of the magnet motor in the manner just described above will now be explained with reference to FIG. 5. The major components of a control system 66 includes a first flux gate window control device 68 and a second flux gate window control device 70. The first control device 68 is disposed coaxially in a level planar relationship depending upon the desired rotational direction and application of desired forces in a gap adjacent to the outer peripheral edge 54 of the inner core plate 24. Similarly, the second control device 70 is disposed coaxially in a level planar relationship depending upon the desired rotational direction and application of desired forces in a gap adjacent to the inner peripheral edge 44 of the outer field plate 22.

The first control device 68 is preferably formed of a relatively smaller annular portion 72 which has plurality of magnetic flux gate windows 74 disposed around its circumference and alignable between a respective one of the inner core magnets and a respective one of the rotor plate magnets on either the top or lower surfaces of the corresponding plates 24, 58. A first flux window arm 76 is provided for moving vertically the control device 68 so that the flux gate windows 74 are aligned with the respective ones of the inner core magnets and rotor plate magnets, thereby allowing flux coupling from the inner core magnets to be coupled with the rotor magnets for selectively producing repulsive forces to cause either clockwise or counter-clockwise rotation of the rotor plate 58.

Likewise, the second control device 70 is preferably formed of a relatively larger annular portion 78 which has plurality of magnetic flux gate windows 80 disposed around its circumference and alignable between a respective one of the field magnets and a respective one of the rotor plate magnets on either the top or lower surfaces of the corresponding plates 24, 58. A second flux window arm 82 is provided for moving vertically the control device 70 so that the flux gate windows 80 are aligned with the respective ones of the field magnets and rotor plate magnets, thereby allowing flux coupling from the field magnets to be coupled with the rotor magnets for selectively producing repulsive forces to cause either clockwise or counter-clockwise rotation of the rotor plate 58.

In this manner, it should be clearly understood that the control devices 68 and 70 are moved vertically upwardly or downwardly and in unison so that the flux gate windows 74 and 80 are aligned with either the clockwise or counter-clockwise inner core, rotor plate and field magnets in the common plane to provide maximum torque. Alternatively, the control devices 68 and 70 can be operated oppositely and independently of each other so as to cause self-braking and deceleration to a station keeping or non-rotational state.

In view of the discussion above and from the drawings, it will be apparent to those skilled in the art that many physical variations of the illustrated magnet motor can be modified or changed without departing from the essential characteristics or scope of the present invention. For example, multiple or identical pairs of stacked and uniformly constructed rotor plates may be provided so as to achieve the bi-directional operation. In particular, where a pair of rotor plates is used, one of the pair of rotor plates contains permanent magnet mounted for producing a counter-clockwise rotation and the other one thereof contains permanent magnets mounted for producing a clockwise rotation.

Similarly, multiple or identical pairs of stacked and uniformly constructed stator plates can be provided containing permanent magnets which interact with corresponding pairs of the rotor plates. While the number of permanent magnets illustrated in the exemplary motor is twelve, this number may be increased or decreased to the optimum number so as to accommodate the particular desired application. Therefore, the magnet motor can be designed and constructed in virtually any desired size in order to achieve the required horsepower needed to accomplish a specific task.

Also, variations may be made to flux gate window control devices by which the magnet motor embodying the principles of the present invention is controlled without exceeding the scope of the invention. The first and second control devices may be designed to operate independently or in tandem with each other so as to effect the desired operation of the motor. Specifically, each of the control devices can be made to have the ability to either occlude completely, occlude partially or allow the flux from the first through third groups of stator magnets to the corresponding fourth and fifth groups of rotor magnets, thereby producing the correct motor operation of initial start of rotation, acceleration, speed regulation, torque application, braking and station-keeping.

Further, the flux gate window control devices may be alternately designed to move radially rather than vertically in order to allow the various groups of magnets to interact. The control devices are preferably constructed of a Mu type metallic composition so as to effectively shield or eliminate all stray magnet flux from actively operating upon the undesired groups of magnets. Since an outside source of energy of some kind is required to cause the initial physical and mechanical movement of only the control devices for operating the magnet motor, this precludes the possibility that the present invention is directed to a perpetual motion machine since these control devices do indeed consume energy derived from the decay of the magnetic flux in the embedded magnets.

From the foregoing detailed description, it can thus be seen that the present invention provides a high efficiency non-electrically induced magnet motor which includes first through third groups of magnets affixed to a stator assembly and fourth and fifth groups of magnets affixed to a rotor assembly for producing mutually repulsive forces to cause rotation of the rotor assembly between counter-clockwise and clockwise directions.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

1. A high efficiency non-electrically induced magnet motor comprising:
a stator assembly including an outer field magnet holder plate, an inner core magnet holder plate, an upper yoke bracket, and a lower yoke bracket;
a rotor assembly having a rotor shaft extending therethrough at its center, said rotor assembly disposed operatively for relative rotation respect to said stator assembly about the rotor shaft between a counter-clockwise direction and a clockwise direction;
said outer field magnet holder plate having a circular cut-out section in its central portion for receiving therein said inner core magnet holder plate and said rotor assembly;
a first group of magnets affixed to a top surface of said outer field magnet holder plate, said first group of magnets consisting of a first plurality of counter-clockwise field permanent magnets spaced apart equiangularly and circumferentially symmetric around an inner peripheral edge;
a second group of magnets affixed to a lower surface of said outer field magnet holder plate, said second group of magnets consisting of a second plurality of clockwise field permanent magnets spaced apart equiangularly and circumferentially symmetric around said inner peripheral edge;
said inner core magnet holder plate being formed of a circularly-shaped disc having a top surfaced and a bottom surface;
a third group of magnets affixed to the top surface of said inner core magnet holder plate, said third group of magnets consisting of a third plurality of counter-clockwise inner core permanent magnets spaced apart equiangularly and circumferentially symmetric around an outer peripheral edge;
said rotor assembly including a circularly-shaped rotor plate having a top surface and a bottom surface;
a fourth group of magnets affixed to the top surface of said rotor plate, said fourth group of magnets consisting of a fourth plurality of counter-clockwise direction induced rotor plate mounted permanent magnets spaced apart equiangularly and circumferentially symmetric around an outer peripheral edge of said rotor plate;
a fifth group of magnets affixed to the lower surface of said rotor plate, said fifth group of magnets consisting of a fifth plurality of clockwise direction induced rotor plate mounted permanent magnets spaced apart equiangularly and circumferentially symmetric around the outer peripheral edge of said rotor plate;
first flux gate window control means for selectively allowing repulsive flux from said counter-clockwise inner core permanent magnets to be coupled to said counter-clockwise direction induced rotor plate mounted permanent magnets for causing rotation of rotor assembly in the counter-clockwise direction; and
second flux gate window control means for selectively allowing repulsive flux from one of said counter-clockwise and clockwise field permanent magnets to be coupled to a corresponding one of said counter-clockwise and clockwise direction induced rotor plate mounted permanent magnets for causing rotation of rotor assembly between the counter-clockwise and clockwise directions.

2. A high efficiency non-electrically induced magnet motor as claimed in claim 1, wherein said lower yoke bracket is formed of a generally U-shaped construction and is provided with arms attached to the lower surface of said outer field holder plate so as to produce rotational stability for said rotor assembly.

3. A high efficiency non-electrically induced magnet motor as claimed in claim 2, wherein said upper yoke bracket is formed of a generally U-shaped construction and is provided with outer arms attached to the top surface of said outer field magnet holder plate and inner arms attached to the top surface of said inner core magnet holder plate so as to produce rotational stability for said rotor assembly.

4. A high efficiency non-electrically induced magnet motor as claimed in claim 1, wherein said counter-clockwise field permanent magnets are oriented so that the same poles of each field magnet is adjacent to the inner peripheral edge.

5. A high efficiency non-electrically induced magnet motor as claimed in claim 4, wherein said clockwise field permanent magnets are oriented so that the same poles of each field magnet is adjacent to the inner peripheral edge.

6. A high efficiency non-electrically induced magnet motor as claimed in claim 1, wherein said counter-clockwise inner core permanent magnets are oriented so that the same poles of each inner core magnet is adjacent to the outer peripheral edge.

7. A high efficiency non-electrically induced magnet motor as claimed in claim 5, wherein said counter-clockwise inner core permanent magnets are oriented so that the same poles of each inner core magnet is adjacent to the outer peripheral edge.

8. A high efficiency non-electrically induced magnet motor as claimed in claim 1, wherein said counter-clockwise direction induced rotor plate mounted permanent magnets are oriented so that their major axes are lying along the radii of said rotor plate.

9. A high efficiency non-electrically induced magnet motor as claimed in claim 8, wherein said clockwise direction induced rotor plate mounted permanent magnets are oriented so that their major axes are lying along the radii of said rotor plate.

10. A high efficiency non-electrically induced magnet motor as claimed in claim 1, wherein said first flux gate window control means includes a relatively smaller annular portion which has a first plurality of magnet flux gate windows.

11. A high efficiency non-electrically induced magnet motor as claimed in claim 10, further comprising a first flux window arm for moving vertically said first flux gate window control means.

12. A high efficiency non-electrically induced magnet motor as claimed in claim 11, wherein said second flux gate window control means includes a relatively larger annular portion which has a second plurality of magnet flux gate windows.

13. A high efficiency non-electrically induced motor as claimed in claim 12, further comprising a second flux window arm for moving vertically said second flux gate window control means.

14. A high efficiency non-electrically induced magnet motor as claimed in claim 13, wherein said first and second flux window arms are operated simultaneously and in unison.

15. A high efficiency non-electrically induced magnet motor as claimed in claim 13, wherein said first and second flux window arms are operated oppositely and independently of each other.

16. A high efficiency non-electrically induced magnet motor comprising:
a stator assembly including an outer field magnet holder plate, an inner core magnet holder plate, an upper yoke bracket, and a lower yoke bracket;
a rotor assembly having a rotor shaft extending therethrough at its center, said rotor assembly disposed operatively for relative rotation respect to said stator assembly about the rotor shaft between a counter-clockwise direction and a clockwise direction;
said outer field magnet holder plate having a circular cut-out section in its central portion for receiving therein said inner core magnet holder plate and said rotor assembly;
at least one counter-clockwise field permanent magnet affixed to a top surface of said outer field magnet holder plate adjacent to an inner peripheral edge;
at least one clockwise field permanent magnet affixed to a lower surface of said outer field magnet holder plate adjacent to said inner peripheral edge;
said inner core magnet holder plate being formed of a circularly-shaped disc having a top surfaced and a bottom surface;
at least one counter-clockwise inner core permanent magnet affixed to the top surface of said inner core magnet holder plate adjacent to an outer peripheral edge;
said rotor assembly including a circularly-shaped rotor plate having a top surface and a bottom surface;
at least one counter-clockwise direction induced rotor plate mounted permanent magnet affixed to the top surface of said rotor plate, and adjacent to an outer peripheral edge of said rotor plate;
at least one clockwise direction induced rotor plate mounted permanent magnet affixed to the lower surface of said rotor plate and adjacent to the outer peripheral edge of said rotor plate;
first flux gate window control means for selectively allowing repulsive flux from said counter-clockwise inner core permanent magnets to be coupled to said counter-clockwise direction induced rotor plate mounted permanent magnets for causing rotation of rotor assembly in the counter-clockwise direction; and
second flux gate window control means for selectively allowing repulsive flux from one of said counter-clockwise and clockwise field permanent magnets to be coupled to a corresponding one of said counter-clockwise and clockwise direction induced rotor plate mounted permanent magnets for causing rotation of rotor assembly between the counter-clockwise and clockwise directions.

17. A high efficiency non-electrically induced magnet motor as claimed in claim 16, wherein said first flux gate window control means includes a relatively smaller annular portion which has a first plurality of magnet flux gate windows.

18. A high efficiency non-electrically induced magnet motor as claimed in claim 17, further comprising a first flux window arm for moving vertically said first flux gate window control means.

19. A high efficiency non-electrically induced magnet motor as claimed in claim 18, wherein said second flux gate window control means includes a relatively larger annular portion which has a second plurality of magnet flux gate windows.

20. A high efficiency non-electrically induced magnet motor comprising:
stator means including an outer field magnet holder plate, an upper yoke bracket, and a lower yoke bracket;
rotor means having a rotor shaft extending therethrough at its center, said rotor means disposed operatively for rotating relative to said stator means about the rotor shaft between a counter-clockwise direction and a clockwise direction;
said outer field magnet holder plate having a circular cut-out section in its central portion for receiving therein said rotor means;
a first group of magnets affixed to a top surface of said outer field magnet holder plate, said first group of magnets consisting of a first plurality of counter-clockwise field permanent magnets spaced apart equiangularly and circumferentially symmetric around an inner peripheral edge;
a second group of magnets affixed to a lower surface of said outer field magnet holder plate, said second group of magnets consisting of a second plurality of clockwise field permanent magnets spaced apart equiangularly and circumferentially symmetric around said inner peripheral edge;
said rotor means including a circularly-shaped rotor plate having a top surface and a bottom surface;
a third group of magnets affixed to the top surface of said rotor plate, said third group of magnets consisting of a third plurality of counter-clockwise direction induced rotor plate mounted permanent magnets spaced apart equiangularly and circumferentially symmetric around an outer peripheral edge of said rotor plate;
a fourth group of magnets affixed to the lower surface of said rotor plate, said fourth group of magnets consisting of a fourth plurality of clockwise direction induced rotor plate mounted permanent magnets spaced apart equiangularly and circumferentially symmetric around the outer peripheral edge of said rotor plate; and
flux gate window control means for selectively allowing repulsive flux from one of said counter-clockwise and clockwise outer field permanent magnets to be coupled to a corresponding one of said counter-clockwise and clockwise direction induced rotor plate mounted permanent magnets for causing rotation of rotor assembly between the counter-clockwise and clockwise directions.
